(19) United States
(12) Patent Application Publication
(10) Pub. No.: US 2017/0231275 A1
(43) Pub. Date: Aug. 17, 2017

(54) E-CIGARETTE SABER ATTACHMENT

(71) Applicant: Sean Guenther, Naperville, IL (US)

(72) Inventor: Sean Guenther, Naperville, IL (US)

(21) Appl. No.: 15/044,290

(22) Filed: Feb. 16, 2016

(51) Int. Cl. A24F 47/00; F21V 23/04; A24F 9/00

(52) U.S. Cl. CPC A24F 47/008; A24F 9/00; F21V 23/04

(57) ABSTRACT

A sleeve attachment for an e-cigarette that includes: a sleeve; opening provided at both ends of the sleeve; and a laser attached to an outer perimeter surface of the sleeve. The laser preferably includes an on/off switch and a laser emission point that directs a laser beam.

### BACKGROUND OF THE INVENTION

Field of Invention

The present invention relates to an attachment for an e-cigarette to create a light saber appearance.

Description of Related Art

Many individuals are enjoying e-cigarettes as an alternative to the conventional tobacco-based cigarettes. E-cigarettes use a batter-operated vaporizer that stimulates smoking. Most of the e-cigarettes are cylindrical in shape although other variations are available. The e-cigarette normally has a heating element that atomizes a liquid solution that creates the smoking effect. This liquid solution may contain various flavoring nicotine, propylene glycol. As a result, e-cigarette smoking has grown in popularity and therefore a number of users have purchased various e-cigarettes for consumption purposes. Various e-cigarettes have various lighting and other types of decorative features to enhance e-cigarette consumption. One science fiction aspect may be available as a means to tie into the e-cigarette consumption.

### SUMMARY OF THE INVENTION

The present invention relates to a sleeve attachment for an e-cigarette that includes: a sleeve; openings provided at each end of the sleeve; and a laser attached to an outer perimeter surface of the sleeve. The laser includes an on/off switch and a laser emission point that directs a laser beam.

### BRIEF DESCRIPTION OF DRAWINGS

FIG. 1 depicts an e-cigarette saber attachment in accordance with the present invention.

FIG. 2 depicts a top view of the e-cigarette saber attachment according to the present invention.

FIG. 3 depicts a side vie of the e-cigarette saber attachment.

FIG. 4 depicts a direct horizontal view of the e-cigarette saber attachment according to the present invention.

### DETAILED DESCRIPTION

The present invention relates to an e-cigarette saber attachment that provides a unique light saber appearance incorporated onto an e-cigarette. The attachment includes a sleeve that slides over a conventional e-cigarette and a laser is attached to an outer portion of the sleeve. Along the outer portion of the sleeve is a laser that emits a laser creating a light saber effect for decorative or entertainment purposes. Once the sleeve is fitted over the e-cigarette, the user may continue to enjoy the e-cigarette and blow out vapors creating the cloud effect normally associated with e-cigarette consumption. The novelty of the light saber allows the user to then emit the laser saber through the clouds providing additional entertainment while enjoying the consumption of the e-cigarette.

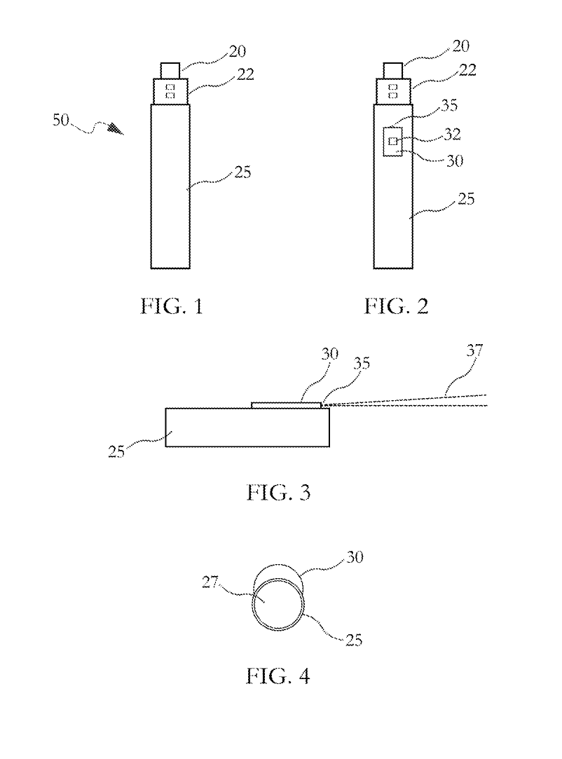

In reference to FIG. 1, an e-cigarette saber attachment 50 is shown. The saber attachment 50 includes a sleeve 25 with a top end 20. A base 22 below the top end 20 fits onto a e-cigarette, not shown. FIG. 2 depicts a top view of the sleeve 25 where a laser 30 is attached to the sleeve 25. The laser 30 includes an on/off switch 32 and a laser emission point 35.

FIG. 3 provides a side view of the sleeve 25 emitting a laser 37 from the laser emission point 35. The laser 37 may be used as desired by the user once the sleeve 25 is placed over a traditional electronic cigarette. A top front view is provided in FIG. 4 showing the entry into the sleeve 25 and opening 27 into the sleeve 25. As shown, the opening 27 of the sleeve 25 is hollow and the laser 30 is on the outer perimeter of the sleeve 25. During use the user may enjoy added entertainment using this novel sleeve attached to an e-cigarette. The instant invention has been shown and described in what it considers to be the most practical and preferred embodiments. It is recognized, however, that departures may be made there from within the scope of the invention and that obvious modifications will occur to a person skilled in the art.

What is claimed is:

1. A sleeve attachment for an e-cigarette comprising:
a. a sleeve;
b. openings provided at each end of the sleeve; and
c. a laser attached to an outer perimeter surface of the sleeve.

2. The sleeve attachment according to claim 1, where the laser includes an on/off switch.

3. The sleeve attachment according to claim 1, where the laser includes a laser emission point.
